(19) United States
(12) Patent Application Publication
(10) Pub. No.: US 2017/0055093 A1
(43) Pub. Date: Feb. 23, 2017

(54) DYNAMICALLY PROGRAMMABLE MICROPHONE

(71) Applicant: INVENSENSE, INC., San Jose, CA (US)

(72) Inventor: Eitan A. Medina, Palo Alto, CA (US)

(21) Appl. No.: 14/951,749

(22) Filed: Nov. 25, 2015

Related U.S. Application Data
(60) Provisional application No. 62/207,355, filed on Aug. 19, 2015.

(51) Int. Cl. H04R 29/00; H04R 3/00; H04R 19/04; H04R 19/00

(52) U.S. Cl. CPC H04R 29/004; H04R 19/005; H04R 3/00; H04R 19/04; H04R 2430/01

(57) ABSTRACT

Various embodiments provide for a dynamically programmable acoustic sensor that can adjust various parameters affecting sensitivity, acoustic overload point, signal to noise ratio and other parametric choices that affect the performance and function of the acoustic sensor. A sound analysis engine can monitor the ambient noise in real time and adjust the parameters in response to changes in the ambient noise. In other embodiments, there can be preset configurations based on various sound profiles, and when the sound analysis engine determines that the ambient noise matches one of the sound profiles, the parameters of the programmable acoustic sensor can be dynamically adjusted to match the preset configuration.

### PRIORITY CLAIM AND RELATED APPLICATIONS

This patent application is a non-provisional application that claims priority to U.S. Provisional Patent Application Ser. No. 62/207,355, filed on Aug. 19, 2015, entitled “DYNAMICALLY PROGRAMMING MICROPHONE PER CONTEXT” the entirety of which is incorporated by reference herein. This patent application is also related to U.S. patent application Ser. No. 14/074,587, filed on Nov. 7, 2013, entitled “MULTI-FUNCTION PINS FOR A PROGRAMMABLE ACOUSTIC SENSOR” the entirety of which is incorporated by reference herein.

### TECHNICAL FIELD

The subject disclosure relates to a dynamically programmable microphone that is adjusted based on ambient noise.

### BACKGROUND

Microphones and acoustic sensors have a variety of parameters that affect the sensitivity, dynamic range, and other sensor behaviors. These parametric choices are traditionally fixed based on the design of the acoustic sensor during the design time or production. If any changes are required to the microphone output, various forms of processing can be performed on the microphone output, but traditionally there has been no way to change the microphone output for a given acoustic input.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented layer.

In a non-limiting example, a dynamically adjustable acoustic device can comprise a programmable acoustic sensor configured to adjust an operating parameter of an acoustic input. The device can also include a sound analysis engine configured to monitor an ambient acoustic environment and generates an acoustic profile based on the ambient acoustic environment. The device can also include a controller configured to send a programming instruction based on the acoustic profile to the programmable acoustic sensor to modify the operating parameter.

In another non-limiting example, a method can comprise receiving an audio signal from a programmable microphone, wherein the audio signal represents an ambient audio environment around the programmable microphone. The method can also include analyzing the audio signal, by a sound analysis engine, and generating a sound profile based on the audio signal. The method can also include determining an adjustment to make to the programmable microphone to improve a performance characteristic of the sound profile, wherein the adjustment adjusts an operational parameter of the programmable microphone. The method can further include programming the programmable microphone to implement the adjustment to the operational parameter.

In yet another non-limiting example, an acoustic sensor device can a programmable acoustic sensor configured to adjust an operating parameter of an acoustic input. The device can also include a sound analysis engine configured to monitor an ambient acoustic environment and match an acoustic profile of the ambient acoustic environment to a saved acoustic profile of a set of saved acoustic profiles. The device can also include a controller configured to send a programming instruction to the programmable acoustic sensor based on a preset operational parameter associated with the saved acoustic profile, wherein the programming instruction is configured to adjust the operating parameter to match the preset operational parameter.

The following description and the drawings contain certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 depicts a non-limiting block diagram of a programmable microphone with settings based on ambient noise according to various non-limiting aspects of the subject disclosure;

FIG. 2 depicts a non-limiting block diagram of a programmable microphone with settings based on ambient noise according to various non-limiting aspects of the subject disclosure;

FIG. 3 depicts a non-limiting block diagram of a programmable microphone according to various non-limiting aspects of the subject disclosure;

FIG. 4 depicts a non-limiting schematic diagram of a programmable acoustic sensor that includes a power pin and a ground pin according to various non-limiting aspects of the subject disclosure;

FIG. 5 depicts an exemplary flowchart of non-limiting methods associated with a dynamically programming an acoustic sensor based on the environment according to various non-limiting aspects of the disclosed subject matter; and

FIG. 6 depicts an example schematic block diagram for a computing environment in accordance with certain embodiments of this disclosure.

### DETAILED DESCRIPTION

### Overview

While a brief overview is provided, certain aspects of the subject disclosure are described or depicted herein for the purposes of illustration and not limitation. Thus, variations of the disclosed embodiments as suggested by the disclosed apparatuses, systems and methodologies are intended to be encompassed within the scope of the subject matter disclosed herein. For example, the various embodiments of the apparatuses, techniques and methods of the subject disclosure are described in the context of MEMs sensors. However, as further detailed below, various exemplary implementations can be applied to other areas of acoustic sensors with programmable input parameters that can be dynamically programmed based on environmental conditions and ambient noises without departing from the subject matter described herein.

As used herein, the terms MEMS sensor, MEMS accelerometer, MEMS gyroscope, MEMS inertial sensor, MEMS acoustic sensor(s), MEMS audio sensor(s), and the like are used interchangeably unless context warrants a particular distinction among such terms. For instance, the terms can refer to MEMS devices or components that can measure acceleration, rate of rotation, a proximity, determine acoustic characteristics, generate acoustic signals, or the like.

Additionally, terms such as “at the same time,” “common time,” “simultaneous,” “simultaneously,” “concurrently,” “substantially simultaneously,” “immediate,” and the like are employed interchangeably throughout, unless context warrants particular distinctions among the terms. It should be appreciated that such terms can refer to times relative to each other and may not refer to an exactly simultaneously action(s). For example, system limitations (e.g., download speed, processor speed, memory access speed, etc.) can account for delays or unsynchronized actions. In other embodiments, such terms can refer to acts or actions occurring within a period that does not exceed a defined threshold amount of time.

Various embodiments provide for a dynamically programmable acoustic sensor that can adjust various parameters affecting sensitivity, acoustic overload point, signal to noise ratio and other parametric choices that affect the performance and function of the acoustic sensor. A sound analysis engine can monitor the ambient noise in real time and adjust the parameters in response to changes in the ambient noise. In other embodiments, there can be preset configurations based on various sound profiles, and when the sound analysis engine determines that the ambient noise matches one of the sound profiles, the parameters of the programmable acoustic sensor can be dynamically adjusted to match the preset configuration.

Various other configurations or arrangements are described herein. It is noted that the various embodiments can include other components and/or functionality. It is further noted that the various embodiments can be included in larger systems, including, smart televisions, smart phones or other cellular phones, wearables (e.g., watches, headphones, etc.), tablet computers, electronic reader devices (i.e., e-readers), laptop computers, desktop computers, monitors, digital recording devices, appliances, home electronics, handheld gaming devices, remote controllers (e.g., video game controllers, television controllers, etc.), automotive devices, personal electronic equipment, medical devices, industrial systems, cameras, and various other devices or fields.

### Exemplary Embodiments

Various aspects or features of the subject disclosure are described with reference to the drawings, wherein like reference numerals are used to refer to like elements throughout. In this specification, numerous specific details are set forth in order to provide a thorough understanding of the subject disclosure. It should be understood, however, that the certain aspects of disclosure may be practiced without these specific details, or with other methods, components, parameters, etc. In other instances, well-known structures and devices are shown in block diagram form to facilitate description and illustration of the various embodiments.

In the described embodiments Micro-Electro-Mechanical Systems (MEMS) refers to a class of structures or devices fabricated using semiconductor-like processes and exhibiting mechanical characteristics such as the ability to move or deform. MEMS devices often, but not always, interact with electrical signals. MEMS devices include but are not limited to gyroscopes, accelerometers, magnetometers, pressure sensors, microphones, and radio-frequency components.

Silicon wafers containing MEMS structures are referred to as MEMS wafers. The MEMS acoustic sensor includes a MEMS transducer and an electrical interface. In an embodiment, the MEMS transducer and the electrical interface can be fully integrated as single die, or in another embodiment a MEMS transducer and the electrical interface can be two separate dies, where the MEMS transducer and the electrical interface are inter-connected via additional pins and bond wires. In either case, the programmable acoustic sensor is coupled to a host system via electrical interface pins. In embodiments, the host system can be a tester used during production and characterization, an end application that acquires the acoustic sensor output or the like

In an embodiment, an analog output acoustic sensor includes a programmable acoustic sensor that includes three pins. In such a system, the three pins are: a power (Vdd) pin, a ground (Gnd) pin and an output (Out) pin. The Vdd and Gnd pins are coupled to the programmable acoustic sensor. The Out pin which is an acoustic sensor output provides an analog output to the host system.

In another embodiment, a digital output acoustic sensor may have five pins. In such a system, the five pins are: a power (Vdd) pin, a ground (Gnd) pin, clock (Clk) pin, left/right (L/F) selection and a digital output (Out) pin. The Vdd, Gnd, Clk and L/F pins are coupled to the programmable acoustic sensor. In the embodiment the digital output (Out) provides an acoustic sensor output to the host system. For example the digital output comprises provides a pulse density modulated (PDM) acoustic sensor output or the like. In order to enable programmability without increasing the number of pins in the programmable acoustic sensor, secondary functions are added to the existing pins. These secondary functions include but are not limited to, detecting a valid communication request, acknowledging the request, receiving data from the host system, sending data to the host system. To describe the features of the present invention in more detail refer now to the following description in conjunction with the accompanying drawings.

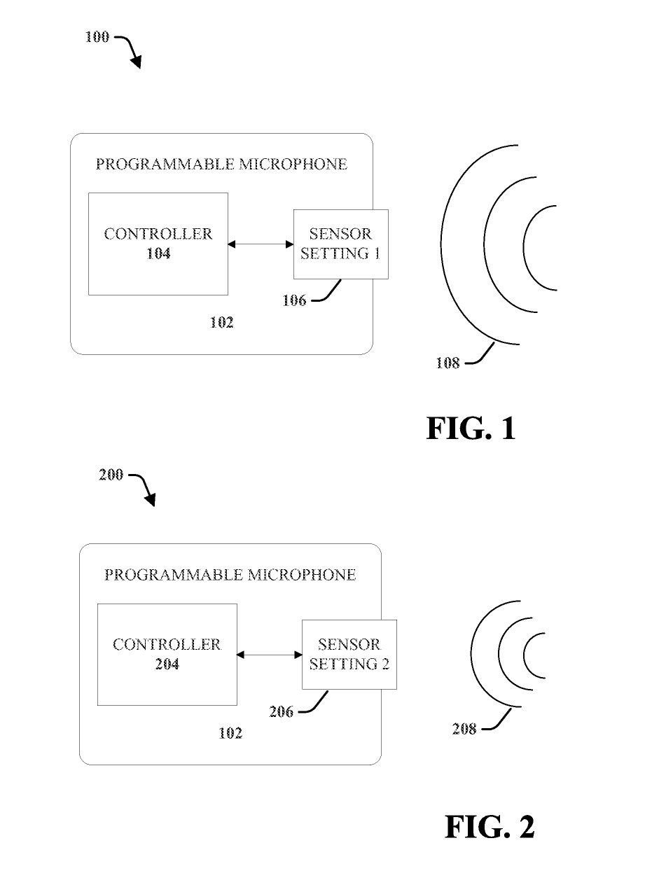

FIG. 1 illustrates an exemplary non-limiting block diagram 100 of a programmable microphone 102 with settings based on ambient noise 108 according to various non-limiting aspects of the subject disclosure.

In an embodiment, programmable microphone 102 can adjust one or more settings to match the ambient noise or environmental context 108. An acoustic sensor 106 can monitor the environmental noise and controller 104 can analyze the noise and adjust a sensor setting based on the environmental context 108. The sensor settings can include various settings that affect the sound pickup including sensitivity, signal to noise ratio, and acoustic overload point, among other parameters.

In the embodiment shown in FIG. 1, the environmental noise 108 maybe relatively large, or larger than a predefined level, and so the controller 104 can select settings (e.g., sensor setting 1) for the acoustic sensor 106 to optimize the acoustic sensor response to the sound 108. For instance, the acoustic overload point can be set such that the sound 108 causes a linear response in the range of amplitudes of sound 108, ie., clipping due to non-linear distortion is minimized or eliminated. In other embodiments, the sensitivity, which is the electrical response at the output to a given standard acoustic input can be set to optimize the signal. The sensitivity which is given as the ratio of the input pressure to the electrical output (voltage or digital word) can be set to provide an optimal signal to noise ratio or dynamic range based on the environmental sound 108.

In an embodiment, the sensor settings can be stored in a memory in the programmable microphone 102, and the controller 104 can program the acoustic sensor with sensor setting 1 based on the stored sensor settings. In an embodiment, the sensor setting 1 can be a predefined sensor configuration based on a sound profile, and when controller 104 determines that the environmental sound 108 matches the sound profile, the controller 104 can read the memory, find the matching preset configuration, and program the acoustic sensor 106 with the preset configuration. In an embodiment, controller 104 can sample the signal received from acoustic sensor 106 at predefined intervals and adjust the settings based on an analysis of the samples. In other embodiments, controller 104 can adjust the settings whenever a variation in the environmental noise 108 is larger than a predefined amount. In an embodiment, the preset configurations can correspond to various sound profiles associated with a set of environments (quiet environment, noisy street, loud party, loud concert, device in pockets, etc.). As the preset configurations are programmed to the acoustic sensor 106, the sensor(s) then are performing optimally as they are adapting their optimization point to environment.

In other embodiments, the controller 104 can continuously sample and/or analyze in real-time the signal received from the acoustic sensor 106 and make adjustments to sensor settings on the fly. These programming changes may not necessarily conform to preset configurations matching various sound profiles, but may be selected by the controller 104 to enhance or modify various aspects of the signal.

Turning now to FIG. 2, illustrated is a non-limiting block diagram 200 of a programmable microphone 202 with settings based on ambient noise 208 according to various non-limiting aspects of the subject disclosure.

In an embodiment, programmable microphone 202 can adjust one or more settings to match the ambient noise or environmental context 208. An acoustic sensor 106 can monitor the environmental noise and controller 204 can analyze the noise and adjust a sensor setting based on the environmental context 208. The sensor settings can include various settings that affect the sound pickup including sensitivity, signal to noise ratio, and acoustic overload point, among other parameters.

In the embodiment shown in FIG. 1, the environmental noise 208 maybe relatively small, or smaller than a predefined level, and so the controller 204 can select settings (e.g., sensor setting 2) for the acoustic sensor 206 to optimize the acoustic sensor response to the sound 208. For instance, the acoustic overload point can be set such that the sound 208 causes a linear response in the range of amplitudes of sound 208, ie., clipping due to non-linear distortion is minimized or eliminated. In other embodiments, the sensitivity, which is the electrical response at the output to a given standard acoustic input can be set to optimize the signal. The sensitivity which is given as the ratio of the input pressure to the electrical output (voltage or digital word) can be set to provide an optimal signal to noise ratio or dynamic range based on the environmental sound 208.

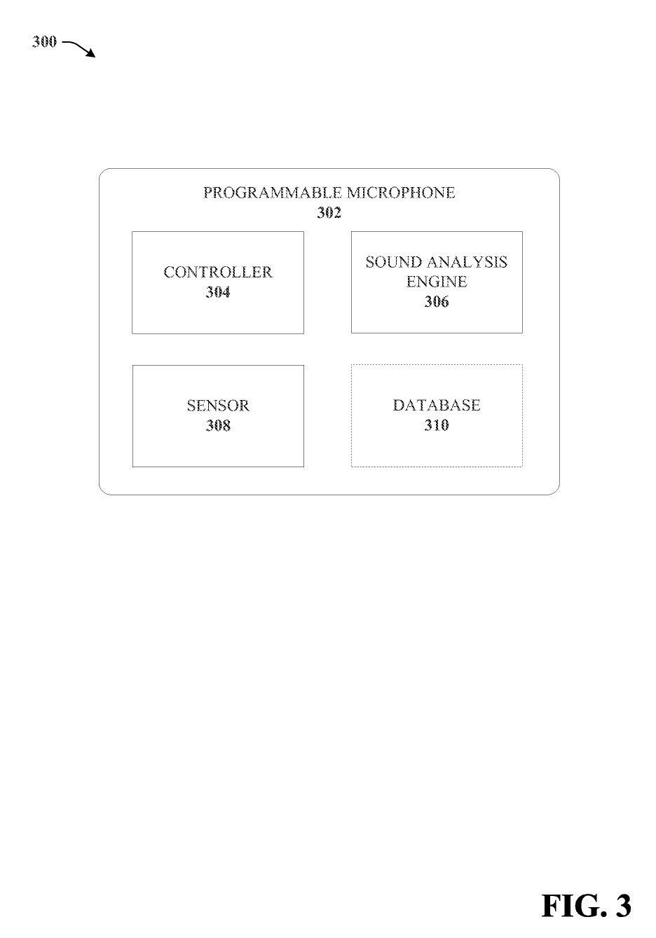

Turning now to FIG. 3, illustrated is a non-limiting block diagram 300 of a programmable microphone 302 according to various non-limiting aspects of the subject disclosure.

Programmable microphone 302 includes an acoustic sensor 308 that can convert pressure waves associated with a sound into electrical impulses, the amplitude of which correspond to the relative amplitude of the pressure waves. The acoustic sensor 308 can include one or more configurable and programmable parameter settings that affect the functionality of the acoustic sensor 308. These parameters can be adjusted in such a way that the sensitivity, acoustic overload point, signal to noise ratio, and other settings can be configured.

A sound analysis engine 306 can analyze the electrical signal produced by the acoustic sensor 308 to determine various characteristics associated with the environmental context. The sound analysis engine 306, based on the electrical signal, can determine what type of environment the programmable microphone 302 is located in currently set (quiet environment, noisy street, loud party, loud concert, device in pockets, etc.) to try and match the environment to a particular profile.

In an embodiment, the sound analysis engine 306 can be realized by a device that determines critical information about the ambient sound environment (by analyzing the sound received by the microphones) and optionally combining motion sensors information, user interface input and other contextual inputs about the position of the device, whether its microphones are occluded (such as in pocket), and using this information determines in what is a more optimal configuration of the sensor 308 critical parameters for the desired condition. Such device may be realized by a processor and memory inside the same package with the microphone 302, or on another chip that communicated with the microphone via a control interface passing the configuration commands

A controller 304 can be provided to program the acoustic sensor 308 with preset configurations based on the sound profile determined by the sound analysis engine 306. In an embodiment, the controller 304 can search a database 310 for predefined or preset configurations that are associated with the sound profile. When a matching preset configuration is found, the controller 304 can program the acoustic sensor 308 with the preset configuration parameters. In an embodiment, the controller 304 can find preset configuration associated with sound profiles that match the environmental context around programmable 302 to within a predefined amount or the closest matching sound profile. The preset configurations can be stored in either volatile or non-volatile memory that can be written to, and could be either individually controlled or grouped into profiles.

In another embodiment, the controller 304 can program acoustic sensor 308 dynamically and in real-time without using preset configurations. Controller 304 can make minor adjustments to one or more parameters without changing other parameters in order to optimize the electronic signal received from the acoustic sensor 308. In an embodiment, the controller 304 can define a new preset configuration in the database 310 and associate the new preset configuration with a newly determined sound profile, also stored in the database 310. In an embodiment, the controller 304 programs the sensor 308 by sending a programming instruction to the sensor 308. The programming instruction can be configured to facilitate the programming change to the sensor 308.

In an embodiment, programmable microphone 302 can include a second sensor that is configured to monitor the background noise, and sound analysis engine 306 monitors the signal received from the second sensor, but the controller 304 programs the acoustic sensor 308 with the parameter changes. The second sensor can be a part of the programmable microphone 302, or in other embodiments, can be on a separate device.

In an embodiment, the programmable microphone 302 can comprise a single package with the controller 304, sound analysis engine 306, sensor 308, and database 310 in the same package. In other embodiments, one or more of the controller 304, sound analysis engine 306, sensor 308, and database 310 can be on a separate package. For instance, the controller 304, sound analysis engine 306, and database 310 can be in a first package, while the sensor 308 is in a second package.

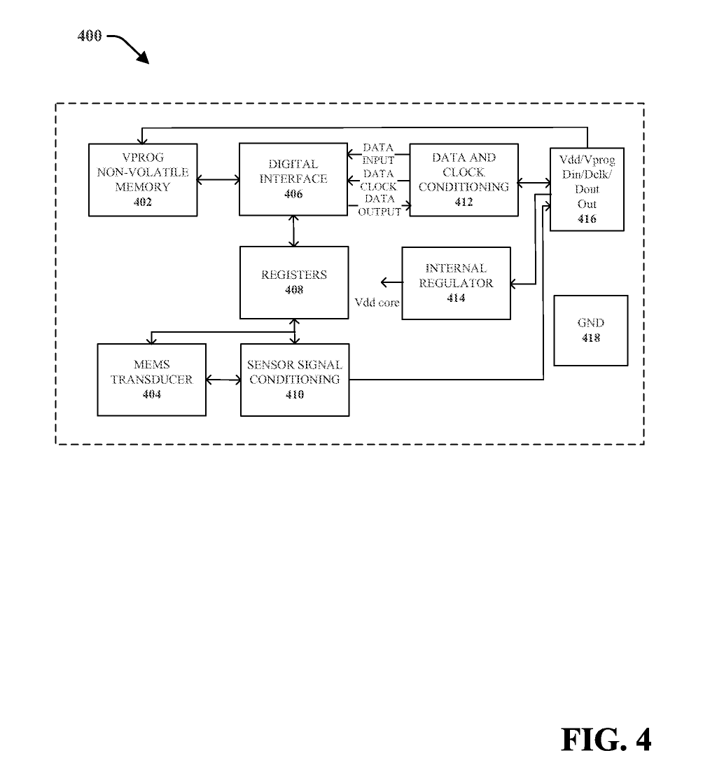

Turning now to FIG. 4, illustrated is a non-limiting schematic diagram of an exemplary integrated sensor and microphone package with a temperature sensor on an application specific integrated circuit that forms part of an integrated die according to various non-limiting aspects of the subject disclosure.

FIG. 4 is a block diagram of a programmable acoustic sensor 400 which includes only two pins. The programmable acoustic sensor 400 includes pins 416 and 418. In an embodiment, the pin 416 is the power pin (Vdd) and the pin 418 is the ground pin. The pin 416 is coupled to a non-volatile memory (NVM) 402, which stores data. The NVM 402 is coupled to a digital interface (DIF) 406 The DIF 406 receives data input and data clock signal and provides data output signals to and from a data and clock conditioning circuit 412. The data and clock conditioning circuit 412 is coupled in a bi-directional manner to the power pin 416. An internal regulator 414 is also coupled to the power pin 416. The DIF 106 is also coupled to one or more registers 408. The one or more registers 408 are coupled to a MEMS transducer 404 and a sensor signal conditioning circuit 410. The sensor signal conditioning circuit 410 in turn is coupled to the power pin 416. In this embodiment the programmable acoustic sensor 100 needs only power pin 416 and the ground pin 418. The power pin 416 also serves as digital input, digital clock, digital output, and the main sensor output. In such a system, the data and clock conditioning circuit 412 can for example translate the data encoded onto the power supply pin 416 into a standard logic level signal that can be fed into the digital interface. The programmable acoustic sensor 400 can therefore receive data and instructions from outside based on the communication channel protocol for any of identifying, programming, reconfiguring, and compensating the programmable acoustic sensor. The programmable acoustic sensor can communicate with a host system from any of test equipment, another sensor, digital signal processor, application processor, sensor hub, coder decode (codec), or the like. The host system may also be capable of dynamically programming, reconfiguring, and compensating the programmable acoustic sensor.

### Exemplary Methods

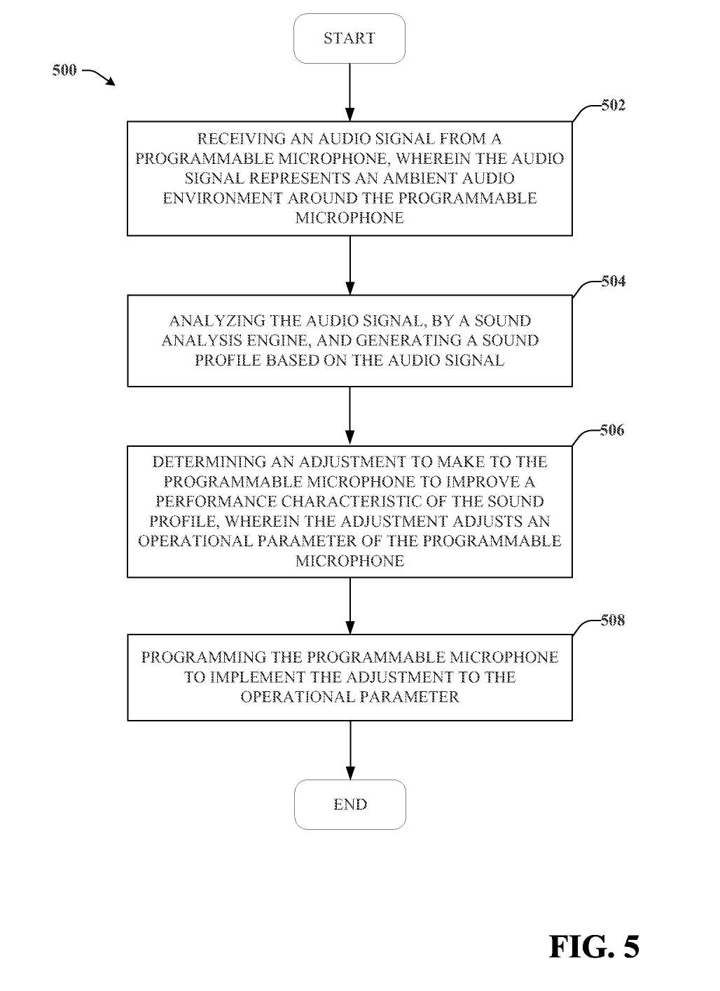

In view of the subject matter described supra, methods that can be implemented in accordance with the subject disclosure will be better appreciated with reference to the flowchart of FIG. 5. While for purposes of simplicity of explanation, the methods are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methods described hereinafter.

FIG. 5 depicts an exemplary flowchart of non-limiting methods associated with a dynamically programming an acoustic sensor based on the environment according to various non-limiting aspects of the disclosed subject matter. As a non-limiting example, exemplary method 500 can facilitate dynamically programming an acoustic sensor based on the environment. The method 500 can start at 502 where the method includes receiving an audio signal from a programmable microphone, wherein the audio signal represents an ambient audio environment around the programmable microphone. The microphone sensor can be a programmable MEMs microphone in some embodiments.

At 504, the method includes analyzing the audio signal, by a sound analysis engine, and generating a sound profile based on the audio signal. At 506, the method includes determining an adjustment to make to the programmable microphone to improve a performance characteristic of the sound profile, wherein the adjustment adjusts an operational parameter of the programmable microphone. At 508, the method includes programming the programmable microphone to implement the adjustment to the operational parameter.

### Exemplary Operating Environment

The systems and processes described herein can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders, not all of which may be explicitly illustrated herein.

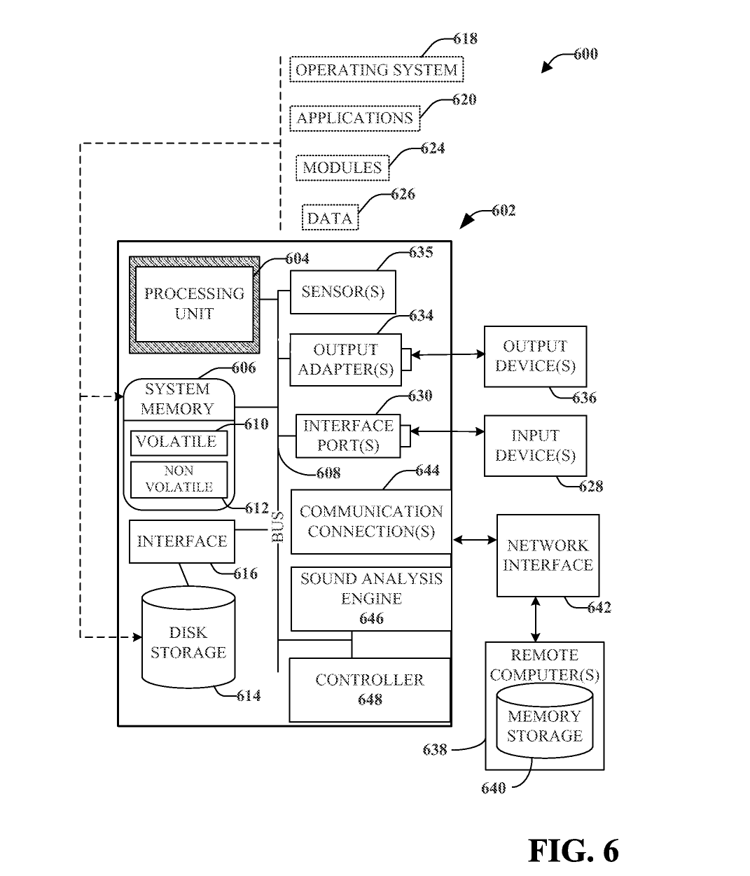

With reference to FIG. 6, a suitable environment 600 for implementing various aspects of the claimed subject matter includes a computer 602. The computer 602 includes a processing unit 604, a system memory 606, sensor(s) 635 (e.g., the MEMS sensor system 102, 202, etc.), and a system bus 608. The system bus 608 couples system components including, but not limited to, the system memory 606 to the processing unit 604. The processing unit 604 can be any of various available processors. Dual microprocessors and other multiprocessor architectures also can be employed as the processing unit 604.

The system bus 608 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 606 includes volatile memory 610 and non-volatile memory 612. The basic input/output system (BIOS), containing the basic routines to transfer information between elements within the computer 602, such as during start-up, is stored in non-volatile memory 612. In addition, according to present innovations, sensor(s) 635 may include at least one audio sensor (e.g., sensor core 108, 208, etc.). In an embodiment, the processing unit 604 and or system memory can process and/or receive a digital signal received from the sensor 635 (e.g., from MEMs sensor 102, 202, etc.). In other embodiments, the processing unit 604 can perform sampling on an analog signal received from the sensor 635 (e.g., sensor 308) using a clock signal received from the sensor 635. By way of illustration, and not limitation, non-volatile memory 612 can include read only memory (ROM), programmable ROM (PROM), electrically programmable ROM (EPROM), electrically erasable programmable ROM (EEPROM), or flash memory. Volatile memory 610 includes random access memory (RAM), which acts as external cache memory. According to present aspects, the volatile memory may store the write operation retry logic (not shown in FIG. 6) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM).

Computer 602 may also include removable/non-removable, volatile/non-volatile computer storage medium. FIG. 6 illustrates, for example, disk storage 614. Disk storage 614 includes, but is not limited to, devices like a magnetic disk drive, solid state disk (SSD) floppy disk drive, tape drive, Jaz drive, Zip drive, LS-100 drive, flash memory card, or memory stick. In addition, disk storage 614 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 614 to the system bus 608, a removable or non-removable interface is typically used, such as interface 616. It is appreciated that storage devices 614 can store information related to a user. Such information might be stored at or provided to a server or to an application running on a user device. In one embodiment, the user can be notified (e.g., by way of output device(s) 636) of the types of information that are stored to disk storage 614 and/or transmitted to the server or application. The user can be provided the opportunity to control having such information collected and/or shared with the server or application (e.g., by way of input from input device(s) 628).

It is to be appreciated that FIG. 6 describes software that acts as an intermediary between users and the basic computer resources described in the suitable operating environment 600. Such software includes an operating system 618. Operating system 618, which can be stored on disk storage 614, acts to control and allocate resources of the computer system 602. Applications 620 take advantage of the management of resources by operating system 618 through program modules 624, and program data 626, such as the boot/shutdown transaction table and the like, stored either in system memory 606 or on disk storage 614. It is to be appreciated that the claimed subject matter can be implemented with various operating systems or combinations of operating systems.

A user enters commands or information into the computer 602 through input device(s) 628. Input devices 628 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 604 through the system bus 608 via interface port(s) 630. Interface port(s) 630 include, for example, a serial port, a parallel port, a game port, and a universal serial bus (USB). Output device(s) 636 use some of the same type of ports as input device(s) 628. Thus, for example, a USB port may be used to provide input to computer 602 and to output information from computer 602 to an output device 636. Output adapter 634 is provided to illustrate that there are some output devices 636 like monitors, speakers, and printers, among other output devices 636, which require special adapters. The output adapters 634 include, by way of illustration and not limitation, video and sound cards that provide a means of connection between the output device 636 and the system bus 608. It should be noted that other devices and/or systems of devices provide both input and output capabilities such as remote computer(s) 638.

Computer 602 can operate in a networked environment using logical connections to one or more remote computers, such as remote computer(s) 638. The remote computer(s) 638 can be a personal computer, a server, a router, a network PC, a workstation, a microprocessor based appliance, a peer device, a smart phone, a tablet, or other network node, and typically includes many of the elements described relative to computer 602. For purposes of brevity, only a memory storage device 640 is illustrated with remote computer(s) 638. Remote computer(s) 638 is logically connected to computer 602 through a network interface 642 and then connected via communication connection(s) 644. Network interface 642 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 644 refers to the hardware/software employed to connect the network interface 642 to the bus 608. While communication connection 644 is shown for illustrative clarity inside computer 602, it can also be external to computer 602. The hardware/software necessary for connection to the network interface 642 includes, for exemplary purposes only, internal and external technologies such as, modems including regular telephone grade modems, cable modems and DSL modems, ISDN adapters, and wired and wireless Ethernet cards, hubs, and routers.

Computer 602 can also include a sound analysis engine 646 and controller 648 that perform the functions associated with the sound analysis engine 306 and controller 304 described above with reference to FIG. 3.

The illustrated aspects of the disclosure may also be practiced in distributed computing environments where certain tasks are performed by remote processing devices that are linked through a communications network. In a distributed computing environment, program modules can be located in both local and remote memory storage devices.

It is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present disclosure. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned diagrams/systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A dynamically adjustable acoustic device, comprising:
a programmable acoustic sensor configured to adjust an operating parameter of an acoustic input;
a sound analysis engine configured to monitor an ambient acoustic environment and generates an acoustic profile based on the ambient acoustic environment; and
a controller configured to send a programming instruction based on the acoustic profile to the programmable acoustic sensor to modify the operating parameter.

2. The dynamically adjustable acoustic device of claim 1, wherein the operating parameter comprises at least one of an acoustic overload point parameter, a sensitivity parameter, and a signal to noise ratio parameter.

3. The dynamically adjustable acoustic device of claim 1, wherein the controller is further configured to send the programming instruction based on data received from a motion sensor.

4. The dynamically adjustable acoustic device of claim 1, wherein the controller is further configured to send the programming instruction based on data received from a user input device.

5. The dynamically adjustable acoustic device of claim 1, wherein the programming instruction is configured to modify the operating parameter to satisfy a predetermined performance characteristic of the programmable acoustic sensor.

6. The dynamically adjustable acoustic device of claim 1, wherein the programming instruction is configured to modify the operating parameter to improve a performance characteristic of the programmable acoustic sensor by a predetermined amount.

7. The dynamically adjustable acoustic device of claim 1, wherein the controller and sound analysis engine are in a separate package from the programmable acoustic sensor.

8. The dynamically adjustable acoustic device of claim 1, wherein the controller is further configured to save the acoustic profile and programming instruction to a memory.

9. The dynamically adjustable acoustic device of claim 1, wherein the sound analysis engine matches the acoustic profile to a saved acoustic profile of a set of saved acoustic profiles wherein the set of saved acoustic profiles is associated with respective saved operating parameters.

10. The dynamically adjustable acoustic device of claim 9, wherein the controller sends a programming instruction to adjust the operating parameter of the programmable acoustic sensor to match a saved operating parameter that is associated with the saved acoustic profile.

11. The dynamically adjustable acoustic device of claim 1, wherein the sound analysis engine is configured to monitor the ambient acoustic environment via an acoustic input received from the programmable acoustic sensor.

12. The dynamically adjustable acoustic device of claim 1, wherein the sound analysis engine is configured to monitor the ambient acoustic environment via an acoustic input received from an acoustic sensor distinct from the programmable acoustic sensor.

13. The dynamically adjustable acoustic device of claim 1, wherein the sound analysis engine generates a new acoustic profile at a predetermined time interval.

14. The dynamically adjustable acoustic device of claim 1, wherein the sound analysis engine generates a new acoustic profile in response to the ambient acoustic environment changing in excess of a predetermined level.

15. A method, comprising:
receiving an audio signal from a programmable microphone, wherein the audio signal represents an ambient audio environment around the programmable microphone;
analyzing the audio signal, by a sound analysis engine, and generating a sound profile based on the audio signal;
determining an adjustment to make to the programmable microphone to improve a performance characteristic of the sound profile, wherein the adjustment adjusts an operational parameter of the programmable microphone; and
programming the programmable microphone to implement the adjustment to the operational parameter.

16. The method of claim 15, wherein the operational parameter of the programmable microphone comprises at least one of an acoustic overload point parameter, a sensitivity parameter, and a signal to noise ratio parameter.

17. The method of claim 16, wherein the programming the programmable microphone comprises adjusting an operational characteristic of a transducer associated with the programmable microphone.

18. The method of claim 15, wherein the determining the adjustment is further based on data received from a motion sensor.

19. The method of claim 15, wherein the determining the adjustment is further based on data received from a user input device.

20. The method of claim 15, further comprising:
storing the sound profile and data representing the adjustment in a memory.

21. The method of claim 15, further comprising:
matching the sound profile to a saved sound profile of a set of saved sound profiles; and
programming the programmable microphone with a second adjustment associated with the saved sound profile.

22. An acoustic sensor device, comprising:
a programmable acoustic sensor configured to adjust an operating parameter of an acoustic input;
a sound analysis engine configured to monitor an ambient acoustic environment and match an acoustic profile of the ambient acoustic environment to a saved acoustic profile of a set of saved acoustic profiles; and
a controller configured to send a programming instruction to the programmable acoustic sensor based on a preset operational parameter associated with the saved acoustic profile, wherein the programming instruction is configured to adjust the operating parameter to match the preset operational parameter.

23. The acoustic sensor device of claim 22, wherein the programmable acoustic sensor is a microelectromechanical systems (MEMS) sensor.
